(19) United States
(12) Patent Application Publication
(10) Pub. No.: US 2007/0152544 A1
(43) Pub. Date: Jul. 5, 2007

(54) Stacking column

(76) Inventor: Gustav Strobel, Bad Saulgau (DE)

Correspondence Address: BACHMAN & LAPOINTE, P.C., 900 CHAPEL STREET, SUITE 1201, NEW HAVEN, CT, 06510, US

(21) Appl. No.: 10/582,046

(22) PCT Filed: Dec. 9, 2004
(86) PCT No.: PCT/EP04/14019

§ 371 Date: Oct. 31, 2006

(30) Foreign Application Priority Data
Dec. 10, 2003 (DE) 103 58 151.0

(51) Int. Cl. A47F 5/08; H01J 13/46

(52) U.S. Cl. 312/9.58; 211/150; 211/41.1

(57) ABSTRACT

A stacking pillar comprising two lateral faces and latches which are disposed therebetween and pivotable around an axle bolt from a neutral position to a working position. At least one part of the latches is provided with the axle bolt reception area which encompasses the axle bolt partly in a curved bow manner.

### BACKGROUND OF THE INVENTION

The present invention relates to a stacking column with two side walls and latches which are arranged between them and rotate about a pin from a rest position into a working position.

Stacking columns are known and are available on the market in a wide variety of shapes and designs. Stacking columns are used, in particular, for the production of vehicle-body parts in the automobile industry. Robots are used to remove the appropriate vehicle-body parts from the presses and to store them temporarily in stacking columns before they are processed further.

It is usual for four stacking columns to be set up in a rectangle. Each stacking column has a multiplicity of latches which are arranged one above an other. A first latch is located in the standby position. If an article is positioned on this latch, the latch pivots into the working position and, at the same time, carries along a following latch, which in this way passes into the standby position. A stacking column of this type is known, for example, from DE 38 11 310 C1.

Stacking columns are also used, however, for the horizontal storage of articles, as is described, for example, in DE 40 20 884 A1. These horizontal stacking columns function in a manner similar to the vertical stacking columns.

It is the object of the present invention to simplify the assembly of stacking columns, in particular those having a small spacing, and to design their handling to be more secure even in the loaded state.

### SUMMARY OF THE INVENTION

The object is achieved by, firstly, at least some of the latches having a pin holder which only partially surrounds the pin in an arcuately curved manner.

It is therefore now possible to first of all secure the pin between the two. side walls and only then to place the latch onto the pin from the side. It is no longer necessary to laboriously search with the pin both for the axial bore in the latch and the bearing bore in the opposite side wall. This substantially simplifies the assembly.

According to the novel invention, the pin also serves to secure adjacent latches. For this purpose, two adjacent pins maintain a distance from each other which is slightly greater than a material thickness of the latch in the region of the pin holder. By this means, it is not possible for the pin to slip out of the pin holder, but nevertheless the pivotability of the latch about the pin is ensured.

With this arrangement, it is possible at the same time to select a different spacing. For example, it is sufficient to configure the diameter of the pins and of the pin holder such that it is larger, as a result of which the distance between two pins also has to be increased, which results in a greater spacing.

The latch is preferably to be in single-piece form, for example is to be composed of sheet metal or a strip of plastic. In this case, on one side of the pin holder the latch forms a supporting part for the object to be held and on the other side is assigned a driver. The latter can have any desired configuration. For example, a projection is sufficient which, when the latch is pivoted, acts upon the following latch and brings it into the standby position. The manner in which this driver is configured and the point at which it is provided on the latch are of secondary importance. For space reasons, it may prove advisable to provide the drivers in an alternating manner opposite one another in the vicinity of the side walls.

It is likewise of secondary importance whether the supporting part protrudes rectilinearly from the pin holder or is of bent design.

According to a further feature of the invention, for which protection is also sought independently, the latches are to be assigned a locking device which fixes at least some, but preferably all, of the latches in the working position. This locking device can be configured as desired.

In a preferred exemplary embodiment of the invention, part of the locking device is a small rail which can be moved in a cutout which is formed in the latches. In the locking position, this small rail is to engage under an upper part of the cutout and is thus to be fixed. In this case, the upper part of the cutout is preferably of planar design, so that the small rail has a relatively large bearing surface.

It is also possible to integrally form projections on the latches without forming cutouts. In this case, the small rail is moved along the latches as far as the projections and engages under them.

The movement of the small rail is brought about by a lever linkage moving in the manner of a parallelogram. However, other configurations are also possible here and are intended to be covered by the concept of the invention.

### BRIEF DESCRIPTION OF THE DRAWINGS

Further advantages, features and details of the invention emerge from the description below of preferred exemplary embodiments and with reference to the drawing, in which

FIG. 1 shows a side view of a stacking column according to the invention in a horizontal position;

FIG. 2 shows a plan view of the stacking column according to FIG. 1;

FIG. 3 shows a perspective view of the stacking column according to FIG. 1;

FIG. 4 shows a perspective view of a stack of latches;

FIG. 5 shows a perspective view of a latch;

FIG. 6 shows a cross section, illustrated in enlarged form, through part of the latch according to FIG. 5;

FIG. 7 shows a perspective view of a locking device according to the invention.

### DETAILED DESCRIPTION

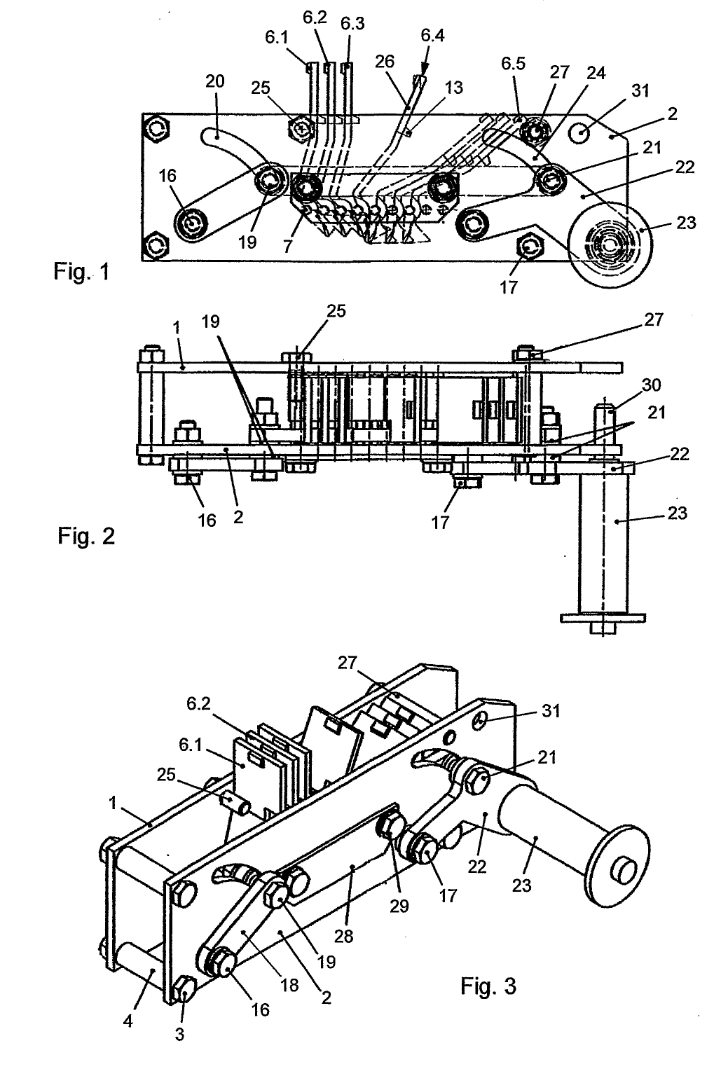

A stacking column according to the invention, as per FIGS. 1 to 3, is illustrated in a horizontal position. It can be used as a horizontal or else vertical stacking column.

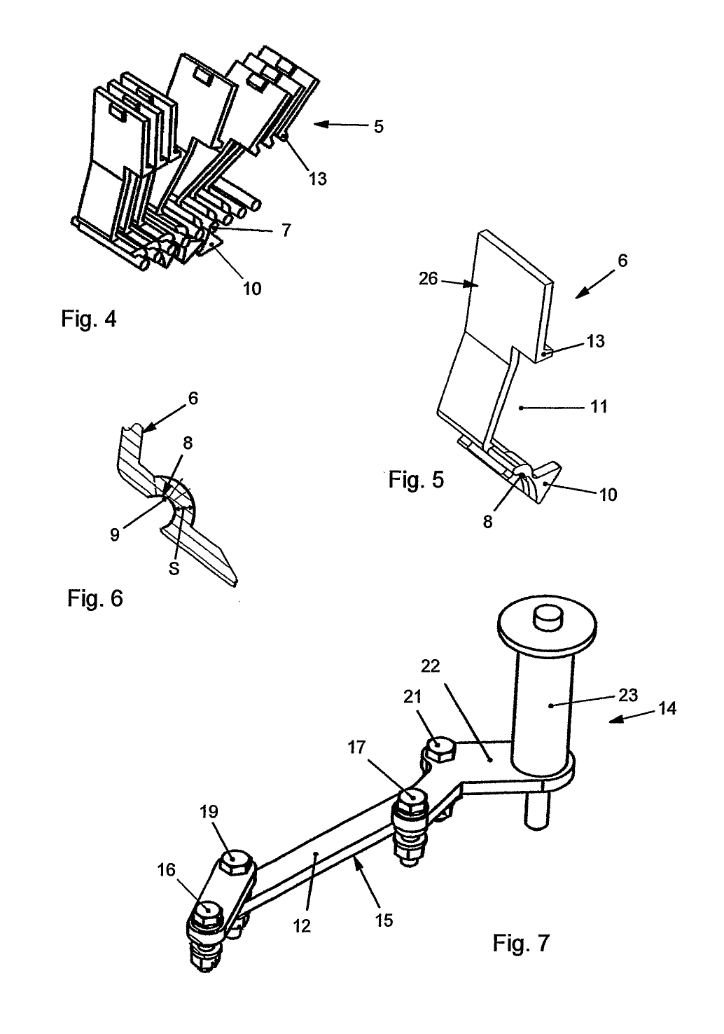

The stacking column has two side walls 1 and 2 which are connected to each other via connecting bolts 3 with corresponding spacer sleeves 4. A stack of latches 5 which is shown in more detail in FIG. 4 is located between the side walls 1 and 2. The stack of latches 5 comprises individual latches 6 of which one is illustrated in enlarged form in FIG. 5. Each latch 6 rotates about a pin 7, said pin 7 being partially surrounded by a pin holder 8, shown in more detail in FIG. 6. The pin holder 8 has an arcuate inner surface 9 with which it at least partially engages around the pin. Furthermore, the latch 6 has a material thickness s in the region of the pin holder 8.

In particular in FIG. 5, below the pin holder 8, a driver 10 can be seen by means of which a following latch can be brought, as described later, from a rest position into a standby position.

Furthermore, the pin holder 8 is followed by a cutout 11 which leads to a reduction in the width of the latch 6. A small rail 12, which can be seen in FIG. 7, moves in this cutout 11. The cutout 11 is upwardly bounded by a stop lug 13 which forms a planar stop.

The small rail 12 is part of a locking device 14 which is shown in FIG. 7. The latter has a parallelogram-like lever linkage 15 which is connected to the side wall 2 in a fixed position via two screw bolts 16 and 17. A lever 18 rotates about the screw bolt 16 and is connected at the other end to the small rail 12 in an articulated manner via a connecting bolt 19. For this purpose, the connecting bolt 19 reaches through a curved slot 20 in the side wall 2, with the connecting bolt 19 being guided in the slot 20. At the other end, i.e. in the interior of the stacking column, the connecting bolt 19 is then connected to the small rail 20 in an articulated manner.

At the other end, the small rail 12 is connected to a triangular pivoting tab 22 via a further connecting bolt 21, with the connecting bolt 21 sitting in one corner and the screw bolt 17 and an actuating lever 23 sitting in the other corners.

The connecting bolt 21 is likewise guided in a curved slot 24, with the connection to the small rail 12 taking place within the stacking column and the connection to the pivoting tab 22 taking place outside the stacking column.

The present invention operates as follows:

Before the latches 6 are installed, the two side walls 1 and 2 are fixed at a distance from each other via the connecting bolts 3 and spacer sleeves 4. Before or after the locking device 14 is installed, the latches are inserted between the two side walls 1 and 2 and the respective pins 7 are placed through corresponding bores in the side wall 2, with them engaging in blind hole bores in the side wall 1. A plate 28 is then placed onto the pins 7 or onto the side wall 2 in the region of the pins 7 and is fixed by screws 29.

According to FIG. 1, the three latches 6.1, 6.2 and 6.3 are already located in the working position, i.e. they hold an object (not shown specifically), for example a vehicle body component, between them. In this case, the first latch 6.1 strikes against a stop 25 and cannot be moved further to the left.

The latch 6.3 has already used its driver 10 to bring a following latch 6.4 into the ready position, so that a supporting part 26 of this latch looks out of the region between the two side walls 1 and 2 and can be acted upon by an object. The other latches are located in a rest position between the two side walls 1 and 2, with the last latch 6.5 bearing against a further stop 27.

If all of the latches 6.1 to 6.5 are in the working position, then the locking device 14 is actuated. That is to say, the actuating lever 23 is acted upon and is pivoted upward. During this pivoting movement, the connecting bolts 19 and 21 move into the respective slots 20 and 24 and, in the process, carry along the small rail 12. This small rail 12 moves upward in the cutouts 11 in the latches and, in the end position, engages under the stop lugs 13, so that the latches cannot move out of their working position. This can only take place if the locking device 14 is brought again into the release position shown in FIG. 3.

To secure the lever linkage 15 in the locking position, use is made of a bolt 30 (see FIG. 2) which can be pulled back via the actuating lever 23. For this purpose, a corresponding spring mechanism is located in the actuating lever 23. In the locking position, the bolt 30 enters a bore 31 in the side wall 2.

1-11. (canceled)

12. A stacking column comprising two side walls (1, 2) and latches (6) arranged between the side walls on a pin (7) for rotation between a rest position into a working position, wherein at least some of the latches (6) have a pin holder (8) which only partially surrounds the pin (7) in an arcuately curved manner.

13. A stacking column comprising two side walls (1, 2) and latches (6) arranged between the side walls on a pin (7) for rotation between a rest position into a working position, wherein the latches (6) are assigned a locking device (14) which fixes at least some of the latches (6) in the working position.

14. The stacking column as claimed in claim 12, wherein at least two adjacent pins (7) maintain a distance from each other which is greater than and substantially the same as a material thickness (s) of the latch (6) in the region of the pin holder (8).

15. The stacking column as claimed in claim 14, wherein the latch (6) is of single-piece design.

16. The stacking column as claimed in claim 14, wherein a driver (10) protrudes from each of the latches (6) downstream of the pin holder (8) and, when the latches (6) rotate about the pin (7), acts on an adjacent latch to move same into a standby position.

17. The stacking column as claimed in claim 16, wherein the drivers (10) of successively following latches are arranged in an alternating manner in the vicinity of respectively opposite side walls (1, 2).

18. The stacking column as claimed in claim 12 or 13, wherein a supporting part (26) is provided downstream of the pin holder (8).

19. The stacking column as claimed in claim 18, wherein the supporting part (26) has a cutout (11) for receiving a part (12) of the locking device (14).

20. The stacking column as claimed in claim 19, wherein a stop lug (13) protrudes from an upper part of the cutout (11).

21. The stacking column as claimed in claim 19, wherein the locking device (14) moves in the cutout (11) of the latch (6) by means of a small rail (12).

22. The stacking column as claimed in claim 21, wherein the small rail (12) is part of a lever linkage (15) moving in the manner of a parallelogram.
